(19) United States
(12) Patent Application Publication
(10) Pub. No.: US 2003/0120752 A1
(43) Pub. Date: Jun. 26, 2003

(54) Dynamic web page caching system and method

(76) Inventor: Michael Corcoran, Vancouver (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/332,811

(22) PCT Filed: Jan. 29, 2001
(86) PCT No.: PCT/CA01/00100

(30) Foreign Application Priority Data
Jul. 11, 2000 (CA) 2,313,802

(51) Int. Cl. G06F 15/16

(52) U.S. Cl. 709/219; 709/203

(57) ABSTRACT

A system for caching dynamic web pages has caching software which intercepts requests for resources from a web server. The caching software determines whether the resource might be cached and, if so, whether it has been cached. If the requested resource has been cached then the caching software redirects the request to the cached resource. If not, the caching software passes the request to the server and waits for the server to forward the resource to the user which requested the resource. The caching software makes and caches a copy of the resource. In preferred embodiments the caching software plugs into the server software. The system can maintain accurate logs of requests for resources. Caching can be dependent upon the query string, header information and/or cookie information. The system can be used to provide increased performance in serving dynamic data.

### CROSS-REFERENCE TO RELATED APPLICATIONS

This application claims the benefit of the filing date of Canadian patent application No. 2,313,802 entitled DYNAMIC WEB PAGE CACHING SYSTEM AND METHOD which was filed on Jul. 11, 2000.

### TECHNICAL FIELD

This invention relates to the delivery of data by way of computer networks, such as the Internet. The invention may be applied to the delivery of web pages from a web server to web clients. The invention has particular application in delivering dynamically updated web pages from a server to client computers.

### BACKGROUND

It is becoming increasingly common to make information in a database available by way of the Internet. Users have computing devices (which may be personal computers, web-enabled devices, or the like) which are connected to the Internet. The users direct requests for data from the database to a server which has access to the database. The server makes an appropriate query of the database to retrieve the requested information and then generates a web page which contains the requested information. The server then delivers the web page to the user. Such systems may use server software such as Microsoft's Internet Information Server (“IIS”) or Apache™ Server from The Apache Software Foundation of Forest Hill, Md., U.S.A. to process and deliver user requests for information.

One difficulty faced by designers of systems for delivering information by way of the Internet or other computer networks is that such systems can become overloaded when they receive a very high volume of user requests. This is particularly a problem when each user request requires a processor in a server to query a database or to conduct other processor-intensive activities. Web servers servicing requests for static pages for which the only processing required is to locate and forward the requested static pages can process requests much more quickly than web servers servicing requests for dynamic data.

It is known that one can use a proxy server to reduce the load on a web server. A proxy server stores copies of static pages from a web server and intercepts requests for those pages before the requests reach the web server. The proxy server services those requests by supplying copies of the requested pages. Traffic on the server is reduced because a number of requests never reach the server. Proxy servers can typically be used only for “static” content. Thus a conventional proxy server cannot be used conveniently to reduce the load on a server which is delivering dynamic content, such as information which is retrieved from a database. One can increase the rate at which requests for dynamic data can be handled by adding additional servers or using more powerful servers. This can be undesirably expensive, however.

Another problem with proxy servers is that it is desirable to keep accurate statistics regarding the number of requests received and processed for specific information. When these statistics are collected at a server and requests are handled by a proxy server then the statistics may be inaccurate because requests handled by the proxy server may not be counted at the server.

With the increasing amount of dynamic data being made available on the Internet, and other networked computer systems there is a need for efficient ways to quickly handle requests for dynamic data.

### SUMMARY OF THE INVENTION

This invention provides methods and apparatus for servicing requests for dynamic data. A first aspect of the invention provides a computer-implemented method for satisfying requests for dynamic data. The method comprises: receiving a request for dynamic data; determining whether a copy of the requested dynamic data is present in a cache data store; if a copy of the requested dynamic data is present in the cache data store, modifying the request to request the copy of the dynamic data in the cache data store and passing the request to a server; and, if a copy of the requested dynamic data is not present in the cache data store, requesting the dynamic data from a server, receiving a copy of the dynamic data from the server and storing the copy of the dynamic data in the data store.

In preferred embodiments there is at least one rule defining one or more types of requests for data which are permitted to be filled from the cache data store and the method includes checking the request for dynamic data to determine whether the request for dynamic data is of a type which is permitted to be filled from the cache data store and, if not, passing the request to the server. The server may comprise a web server and the request for dynamic data may be a HTTP request.

Another aspect of the invention comprises apparatus for satisfying requests for dynamic data. The apparatus comprises a computer running software, the software including instructions which, when run by the computer, cause the computer to: receive a request for dynamic data; determine whether a copy of the requested dynamic data is present in a cache data store; if a copy of the requested dynamic data is present in the cache data store, modify the request to request the copy of the dynamic data in the cache data store and pass the request to a server; and, if a copy of the requested dynamic data is not present in the cache data store, request the dynamic data from a server, receive a copy of the dynamic data from the server and store the copy of the dynamic data in the data store.

Yet another aspect of the invention provides a computer readable medium comprising instructions which, when executed by a computer, cause the computer to perform a method for satisfying requests for dynamic data. The method implemented by the computer executing the instructions comprises: receiving a request for dynamic data; determining whether a copy of the requested dynamic data is present in a cache data store; if a copy of the requested dynamic data is present in the cache data store, modifying the request to request the copy of the dynamic data in the cache data store and passing the request to a server; and, if a copy of the requested dynamic data is not present in the cache data store, requesting the dynamic data from a server, receiving a copy of the dynamic data from the server and storing the copy of the dynamic data in the data store.

Other features and advantages of this invention are described below.

### BRIEF DESCRIPTION OF DRAWINGS

FIG. 1 is a schematic block diagram illustrating a system according to the invention;

FIG. 2 is a block diagram illustrating the relationship between software components of a specific implementation of the invention; and,

FIG. 3 is a flow chart illustrating a method according to the invention.

The terms SPIDERCACHE™ SPIDERCLIENT™, which appear in this disclosure and the accompanying drawings are a trademarks of the assignee of this invention.

### DESCRIPTION

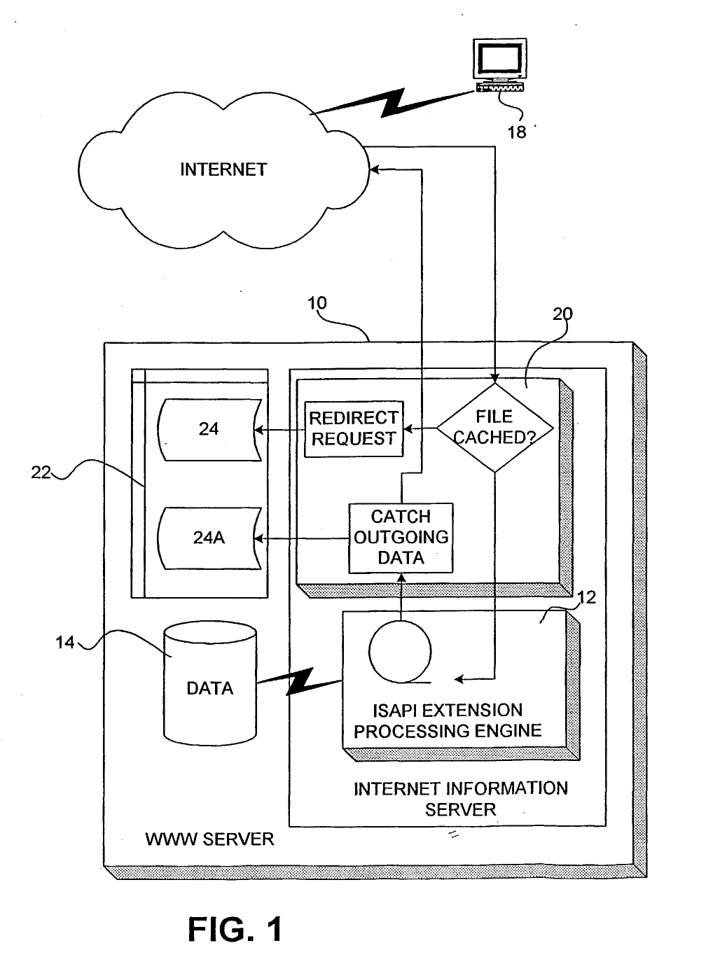

As shown in FIG. 1, according to the currently preferred embodiment of the invention, a web server computer 10 runs web server software 12 such as Microsoft Internet Information Server or Apache Server. Web server software 12 is capable of retrieving information from a database 14 in response to requests received from client computers 18 by way of a network 16, such as the Internet, an intranet or the like. The requests are most typically in the form of HTTP (HyperText Transfer Protocol) requests.

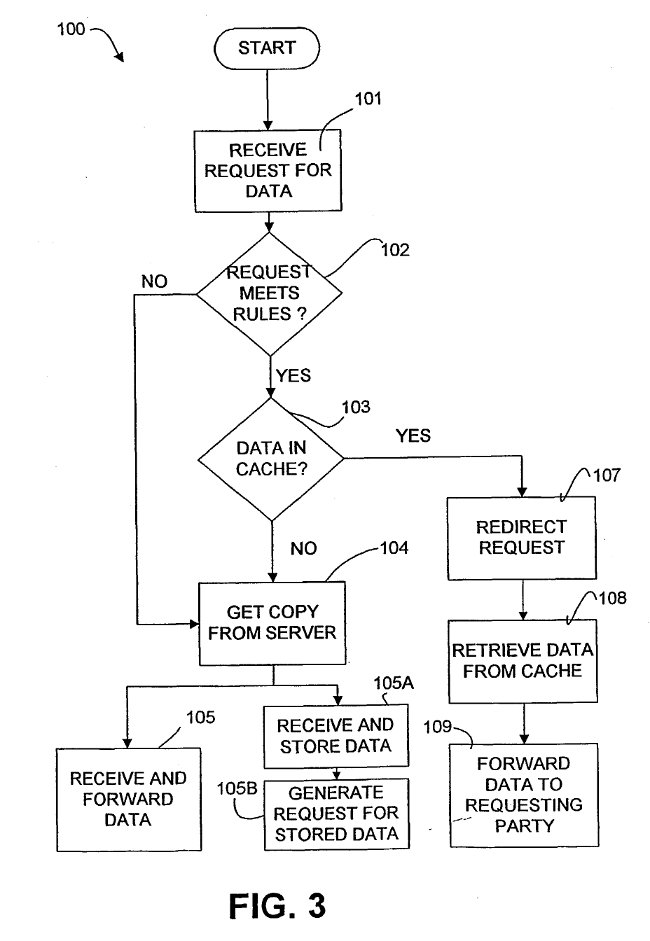

Cache software 20 runs on a computer, which may be web server 10, which is in a data path between web server 10 and client computers 18. Cache software 20 has access to a data store 22 which contains cached files 24. Data store 22 may comprise a storage device, a memory area or the like. Cache software 20 receives requests for data which are directed to server software 12 (step 101, FIG. 3). Cache software 20 determines whether the requested data resides in a cached file 24 in data store 22 (step 103). If so, then instead of passing the request directly to server software 12, cache software 20 modifies the request to point to the cached data file 24 (step 108) and then passes the modified request to server 10. Server 10 then accesses the cached data in data store 22 and returns to the requesting computer 18 data from the cached file 24 (step 109).

If the requested data is not cached in data store 22 then cache software 20 forwards the request to server software 12 (step 104). Server software 12 processes the request by querying database 14 and returns data resulting from the query to the computer 18 in response to the request. Cache software 20 receives and saves as a cached file 24A in data store 22 a copy of the outgoing data. In some embodiments, cache software 20 receives the outgoing data and then forwards the outgoing data to the requesting party (step 105). In other embodiments, cache software 20 receives the outgoing data, stores the outgoing data in data store 22 (step 105A) and then prompts server software 12 to forward the cached data from data store 22 to the requesting party (step 105B).

If cache software 20 subsequently receives another request for the same data then cache software 20 will modify the request to a request for the copy of cached file 24A. Server software 12 can process this request in much less time than it would take to query database 14 to recreate the data in cached file 24A. The load on server 10 is reduced since cache software 20 relieves server 10 from processing any request which can be satisfied by providing a file cached in data store 22. Preferably (to conserve space in data store 22) cached files 24 are compressed. As a simple example, the compressed files may be HTML files with white spaces and/or comments removed.

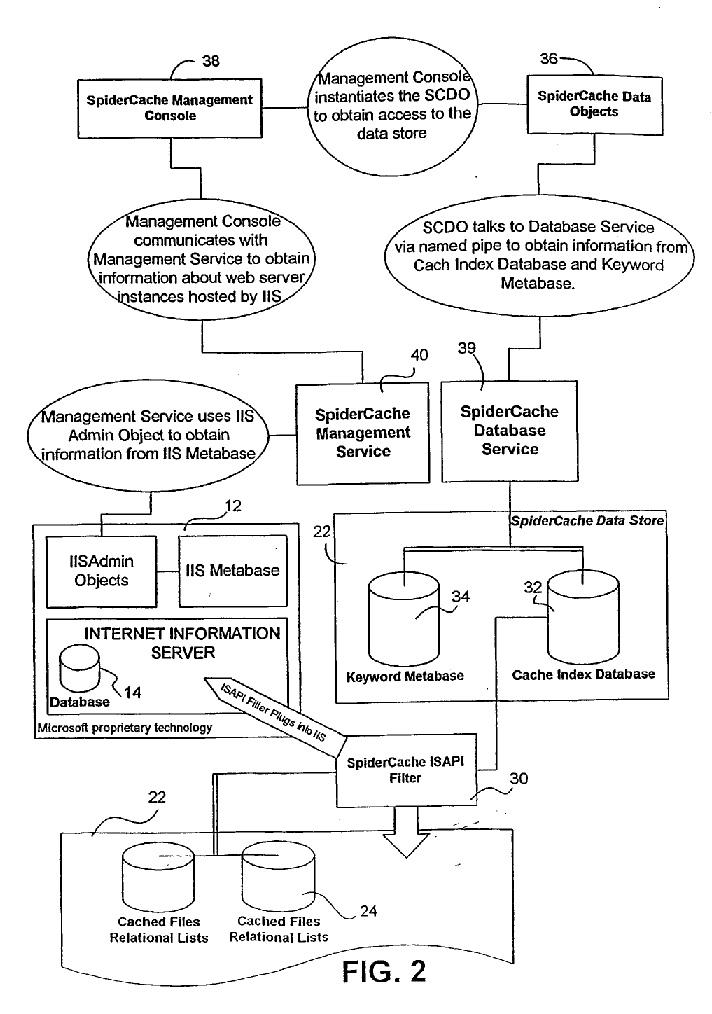

As shown in FIG. 2, in a currently preferred embodiment of the invention, cache software 20 is provided in the form of a “plug-in” which can attach itself to web server software such as Microsoft's IIS via an Internet Server Application Programming Interface (ISAPI) Filter 30. This is accomplished by the IsapiCache DLL by exporting three procedures—GetFilterVersion, HttpFilterProc and TerminateFilter. The ISAPI Filter 30 monitors all incoming requests to the web server 12 and identifies requests which have contents which match specific patterns (step 102). The content to be watched for by filter 30 may be defined by the website developers and/or administrators. Filter 30 may provide a series of rules which define queries which may be satisfied by cached data from data store 22 and/or queries which cannot be satisfied by supplying cached data from data store 22. Content that is not recognized as requiring handling by cache software 20 may be simply passed to web server 12 for processing by web server 12.

The ISAPI Filter framework for IIS is described in “Developing ISAPI Filters”. This document can be found at http://msdn.microsoft.com/library/psdk/iisref/isgu3vn7.htm The complete contents of this document, as of the filing date of this application, is incorporated by reference herein.

For example, a file called “Stories.asp” may be defined as a file which should be cached by cache software 20. If filter 30 receives a request from a user for the file Stories.asp for viewing at a client computer 18, filter 30 identifies and flags that incoming request for further processing. If filter 30 determines that the request for “stories.asp” can be satisfied from data in data store 22 then filter 30 may supply the cached file 24 to the user instead of passing the request for processing by the web server software 12. If filter 30 determines that the request for “stories.asp” cannot be satisfied by supplying a file from data store 22 then filter 30 passes the request to the server software 12. Server software 12 then processes the request for Stories.asp. This may involve database queries and/or dynamic content generation. Server software 12 then send back the generated page to the user.

Because filter 30 has identified the request for stories.asp as requiring special handling, filter 30 captures the reply which server software 12 generates and writes a copy of the reply to data store 22. The next time the user requests “stories.asp” cache software 20 redirects the request to the cached file 24, thus making it unnecessary for server 12 to regenerate the file.

### EXAMPLE 1

### Implementation for use with Microsoft's IIS

A specific embodiment of the invention includes cache software 20 developed using Borland's Delphi 4.0 software development environment. This embodiment of cache software 20 runs in the Microsoft Windows environment. Cache software 20 includes multiple modules that run independently of each other, but communicate with one another other. Table I lists primary components of a current version of cache software 20. A primary functioning module of this embodiment of cache software 20 is the IsapiCache DLL. This DLL plugs into the Microsoft Internet Information Server as an Internet Server Application Programming Interface (ISAPI) Filter. As is known to those skilled in the art, the IIS architecture allows the integration of DLLs into its ISAPI Filter framework.

TABLE I
COMPONENTS OF CACHE SOFTWARE

| NAME | DESCRIPTION |
|---|---|
| IsapiCache.dll | Provides caching functions |
| SCNTService.exe | Windows NT application that runs on a |
| | web server. Acts as a listener for a |
| | client application to perform database |
| | management and cache operation. |
| SCDO.dll | A data object. Preferably a |
| | COM/ActiveX object that provides a |
| | convenient interface to data affecting |
| | the operation of cache software 20. Can |
| | also be used to provide cache |
| | maintenance commands to management |
| | service 40. |
| SpiderClient.exe | A front-end user interface which allows |
| | administration of cache software 20 and |
| | the database of cache software 20 |

The ISAPI Filter (IsapiCache.dll) is registered with IIS by adding a ‘node’ to the IIS Metabase. When IIS loads IsapiCache.dll, IIS asks IsapiCache what IIS events IsapiCache would like to be notified of. In the example embodiment described herein, IsapiCache requests that IIS provide notifications about seven IIS events. These events are indicated by the constant values set out in Table II that are passed to IIS during load time. In the processing of a typical HTTP request the listed events occur in the listed order.

TABLE II
EVENTS

| Constant | Description |
|---|---|
| SF_NOTIFY_{—} | A single |
| PREPROC_HEADERS | SF_NOTIFY_PREPROC_HEADERS |
| | notification will occur for each request. This |
| | notification indicates that the server has |
| | completed pre-processing of the headers |
| | associated with the request, but has not yet |
| | begun to process the information contained |
| | within the headers. |
| SF_NOTIFY_URL_{—} | A SF_NOTIFY_URL_MAP notification will |
| MAP | occur after the server has converted the |
| | virtual URL path contained in the HTTP |
| | request into a physical path on the server. |
| | Note that this event may occur several times |
| | for the same request. |
| SF_NOTIFY_SEND_{—} | The SF_NOTIFY_SEND_RESPONSE event |
| RESPONSE | occurs after the request is processed and |
| | before headers are sent back to the client. |
| SF_NOTIFY_SEND_{—} | As the request handler returns data to the |
| RAW_DATA | client, one or more |
| | SF_NOTIFY_SEND_RAW_DATA |
| | notifications will occur |
| SF_NOTIFY_END_{—} | At the end of each request, the |
| OF_REQUEST | SF_NOTIFY_END_OF_REQUEST |
| | notification occurs. |
| SF_NOTIFY_LOG | After the HTTP request has been completed, |
| | the SF_NOTIFY_LOG notification occurs |
| | just before IIS writes the request to the IIS |
| | log. |
| SF_NOTIFY_END_{—} | When the connection between the client and |
| OF_NET_SESSION | server is closed, the |
| | SF_NOTIFY_END_OF_NET_SESSION |
| | notification occurs. If a Keep-Alive has been |
| | negotiated, it is possible that many HTTP |
| | requests occur before this notification occurs. |

Cache software 20 causes the computer on which it is running to perform various actions. IsapiCache.dll handles the SP_NOTIFY_PREPROC_HEADERS event. When this event occurs, computer instructions in IsapiCache.dll cause the computer on which IsapiCache.dll is running to examine the incoming HTTP request. It finds the resource that the request is looking for, and then checks that against its Cache Index Database 32 to determine whether the requested resource is flagged for caching. If the resource is NOT flagged for caching then, IsapiCache extracts itself from the rest of the request process (i.e. no more SF_NOTIFY notifications for this request occur). If the resource is flagged for caching then IsapiCache checks its cache of files to see if the requested resource is already cached. If the requested resource is already cached, then IsapiCache redirects the request to the cached resource and extracts itself from the rest of the request process.

Preferably cache software 20 provides a facility which permits an administrator to specify rules which will determine whether or not files will be cached based upon custom settings including HTTP header information, cookie information, and query string information. Whether or not a specific resource is cached is conditional depending upon whether the request satisfies the rules.

If the requested resource is flagged for caching but is NOT cached, then IsapiCache attaches some data to the request to allow itself to follows the request through the request process.

IsapiCache extracts the requested resource by asking IIS for the Universal Resource Locator (URL) within the HTTP request header. IsapiCache parses the returned information to find the QueryString, the FileName and the Path. For example: a URL equal to /home/products/spidercache.asp?id=29 would be parsed as QueryString: id=29, FileName: spidercache.asp, Path: /home/products/

IsapiCache then uses this information to extract itself from the request process if possible by comparing the file extension of the FileName against a list of cacheable file extensions to see if it can ignore the request. If the FileNames file extension is in the list, IsapiCache does a lookup in its Cache Index Database 32 to see if the file should be cached (i.e. the administrator has specified this file as one to cache).

If IsapiCache does not find a match in the Cache Index Database 32, it removes itself from the request process. If it finds a match, it accesses the caching properties and settings for this individual file from the Cache Index Database 32 to use in a comparison algorithm to see if the requested resource has already been cached. IsapiCache examines the cache file settings to first see if the resource is set to cache based on the QueryString value only, or if it is set for custom caching via the “Parameterized Caching” technology. If the setting specifies that the file is cached based on query string only, IsapiCache searches cache index database 32 to find a file in data store 22 which corresponds to a matching query string value. If IsapiCache finds a match it redirects the user's request to the cached file.

If the setting specifies that the file is cached based on parameterized caching, IsapiCache compares the parameterized caching requirements to rules specified by the administrator for this file (the rules may include, for example conditions on query string, header and cookie values that must equal certain values or ranges of values, must not equal certain values or ranges of values or must not exist) with the information that is found in a “Cached Files Relational List” for the requested file. If a match is found, IsapiCache redirects IIS to the cached resource and removes itself from further participation in the IIS request process for that resource.

In some cases different data should be returned in response to the same query string depending upon the values of header fields or cookie values. If only the query string were used to identify cached data, the wrong data might be returned in some circumstances. For example, it may be desired to provide data which differs somehow in response to the geographical location of the user or the web browser software being used by the user. Parameterized caching may be used to ensure that the correct data is cached and delivered. Parameterized caching may be used, for example, to cache files based on the location or identity of the user or agent (as identified in the header accompanying a request), to cache files based on the language of the requested resource, or the like.

If a match cannot be found in any of the above situations, IsapiCache proceeds following the request through the IIS request process and caches the requested resource during the SF_NOTIFY_SEND_RAW_DATA event, as described below.

IsapiCache processes the SF_NOTIFY_URL_MAP event. IsapiCache uses this event to notify itself of any files that are ‘included’ within the requested resource. IsapiCache keeps any included file paths in memory for use later on in the request process.

IsapiCache.dll handles processing of the SF_NOTIFY_SEND_RESPONSE event. When IsapiCache.dll is notified of the occurrence of the SF_NOTIFY_SEND_RESPONSE event then IsapiCache.dll examines the ‘Transfer-Encoding:’ response header to determine if the response is ‘CHUNKED’ or not.

IsapiCache.dll handles processing of the SF_NOTIFY_SEND_RAW_DATA event. When IsapiCache.dll is notified of the occurrence of the SF_NOTIFY_SEND_RAW_DATA event it caches the requested resource for use in servicing subsequent requests for the same resource. This event occurs repetitively until all data, in response to the request, has been sent to the requester. IsapiCache writes all of the outgoing data to data store 22 at an appropriate cache location. Preferably, cache software 20 can recognize in the data symbols which signify portions of the data which should not be cached. When such symbols are present in the data being returned by server software 12, IsapiCache.dll detects the symbols and does not cache portions of the data that are flagged for ‘NO CACHE’. The symbols may include a symbol indicating the start of a portion of the data that should not be cached and an end of the portion of the data that should not be cached. Most preferably cache software 20 permits individual files to be identified as files which should not be cached. This permits an operator to temporarily stop a selected file or resource from being cached without affecting other settings.

This is also where ‘included’ files are used. If the outgoing data includes a section of code that is flagged for ‘NO CACHE’, IsapiCache attempts to identify a file that contains suitable source code, such as HTML source code, ASP (active server pages), CGI(common gateway interface), PHP, JSP (java server pages) or other scripting language, for generating the data in the NO CACHE section. This code may be in one of the included files. If IsapiCache can find the source code, then IsapiCache writes the source code to disk, rather than the outgoing data. This permits pages to be semi-cached. Parts of the page remain dynamic, while the rest is cached.

For example, in a preferred embodiment of the invention, as the SF_NOTIFY_SEND_RAW_DATA event occurs IsapiCache intercepts and examines the outgoing data for specific flags that trigger specific processing under the control of the IsapiCache DLL. Some different types of flags that may be encountered during this process are:

1) The ‘End Of File Header’ flag;

2) The ‘Begin No Cache’ and ‘End No Cache’ flags;

3) The ‘Begin Script’ and ‘End Script’ flags; and,

4) The ‘End Of File Marker’ flag.

The End Of File Header flag is signified by the following syntax within an HTML document: <!--sc:end file header-->. IsapiCache only recognizes this flag if it is in the first response stream sent out by IIS after IIS has returned the response HTTP header. It is used to tell IsapiCache to include in the cached file all source code from the original source file that exists before the same flag in the source file.

The ‘Begin No Cache’ and ‘End No Cache’ flags can exist anywhere within the source file, including included files (using the #include directive), and is used to signal IsapiCache to stop caching the outgoing data stream and instead search the source files (files is plural here because of the possibility of included files using the #include directive) for the matching flags and extract the source code and cache from those file(s) instead. The end result is that, in the cached file, there is source code (which may be HTML source code or source code in another scripting language) that was extracted from the original source file—before IIS processed it.

The ‘Begin Script’ and ‘End Script’ flags may also appear anywhere within the source file and are used to signal IsapiCache to modify the data it writes to the cached files. For example, if the ‘Begin Script’ flag is ‘<!--sc:begin script’, then IsapiCache will replace the occurrence of ‘<!--sc:begin script’ with (excluding single quotes) a delimiter as specified by the BeginScriptDelimiter setting. If ‘sc:end script-->’ is the ‘End Script’ flag, then IsapiCache will replace the occurrence of ‘sc:end script-->’ with (excluding single quotes) a delimiter as specified by the EndScriptDelimiter setting. For example, the BeginScript delimiter could be ‘<%’ followed by a number of space characters, and the EndScript delimiter could be a number of space characters followed by (excluding single quotes) ‘%>’. This allows for new code that was not present in the original source file, to exist in the cached file. The BeginScriptDelimiter and EndScriptDelimiter settings are preferably associated with the target file. For example, in the currently preferred embodiment, these settings are located in the Cache Index Database and associated with the target file. Different script delimiters can be selected for use with different programming languages.

The ‘End Of File Marker’ flag is placed at the end of the file and is used to indicate that the file was executed successfully and was fully processed. The theory is that if the file was executed without errors by IIS, and the End Of File Marker is found in the response stream sent back to the requester, then the IsapiCache filter can assume that the cached file is valid. The End Of File Marker is specified in the EOF Marker Setting in the Cache Index Database.

IsapiCache handles processing of the SF_NOTIFY_END_OF_REQUEST event. On the occurrence of this event, IsapiCache closes open file handles and dispose of the allocated memory occupied by the ‘included’ files.

The IsapiCache.dll processes the SF_NOTIFY_LOG event. This event is triggered when IIS is about to log information to the website log files. Preferably caching software 20 can be configured to either log the requests made of web server software 12 or to log the source of the data used to fulfil those requests (including requests which have been redirected by caching software 20).

The IsapiCache.dll processes the SF_NOTIFY_END_OF_NET_SESSION event. On the occurrence of this event, IsapiCache cleans up any resources used during the request process (i.e releases memory).

In the preferred embodiment, caching software 20 provides an interface which allows administrators to control and customize its operation. This may be accomplished, for example, by implementing Windows NT services that allow the configuration and management of the resources provided by cache software 20.

A cache software management service provides multi-threaded access to the configuration, settings and properties of both cache software 20 and server software 12, as well as the files and virtual path information managed by server software 12. This service opens a Named Pipe to communicate with multiple clients by creating new threads to service those clients.

A Database Service provides multi-threaded access to the Index Database 32 of cache software 20 as well as a Keyword Metabase 34. This service opens a Named Pipe to communicate with multiple clients by creating new threads to service those clients. This service provides access to a central data store of cached resource properties and settings. Cache Index Database 32 and Keyword Metabase 34 preferably have a variable field length database format.

Management may be provided by manipulating properties of a cache software Data Object (SCDO) 36 and a management console 38. A current version of cache software 20 provides eight (8) COM objects for the management of the cache and cached file settings and properties. These COM Objects open a Name Pipe to the Database Service 39 to gain access to the Cache Index Database 32 located on a given server. The SCDO Objects 36 are a primary method of accessing the Cache Index Database 32.

Management Console 38 is provided to configure all settings and properties of cache software 20 via a Graphical User Interface. All data, settings and properties are kept in a central location on the server. Management Console 38 accesses the information it requires from Data Objects 36 and Management Service 40 using Named Pipes.

The Management Console 38 connects to the Management Service 40 to receive appropriate information regarding the Server settings, IIS configuration and files. The Management Console also uses the SCDO Objects 36 to gain access to the Cache Index Database 32 which holds all information about the website resources that are flagged for caching.

### EXAMPLE 2

### Apache Server Implementation

The invention may be implemented in the Apache Server environment by providing cache software in the form of a module which is accessible to Apache Server. The module may be compiled right into the Apache Server executable code or, in the alternative, may act as an external executable that Apache can load dynamically, when necessary.

Apache Server is configured to refer certain types of request to the cache software module. This may be done by including in the Apache Server configuration file a directive which causes the caching software module to be the handler for certain types of request.

When the caching software module is notified of a request by the Apache Server, it checks to see if it has previously cached the requested data. If the cache software has a cached instance of the requested data then it performs an Apache internal redirect to the cached file without affecting other Apache operations (such as logging). After this action has been taken then the cache software module is dropped from the request process. Apache handles the request by returning the cached instance to the requesting party.

If the cache software does not have a cached instance of the requested data, then the cache software creates a “sub-request” (as described in the Apache technical documentation which can currently be found on-line at http://www.apache.org) for the requested information. The sub-request is processed by the Apache Server (using whatever module is the appropriate handler for the request) in the same manner that it would be if the cache software were not present. The requested information is then returned to the caching software without sending any data to the requesting user. When the cache software module receives control of the request, it receives a data structure that contains the results of the request, as provided by the appropriate handler. The cache software then writes the results of the request to its cache and proceeds as described above for the case where the caching software has a cached file for the given request.

Cache software 20 may be configured to permit the use of a cached file only within a certain time period after its creation. For example, a cached file may be kept available only for 1 week, 1 day, 2 hours, 3 minutes, or the like. Preferably, expiration times may be associated with individual cached files. This permits the expiration time to be set with reference to the type of file in question or even with reference to an individual file.

It can be appreciated that, in the preferred embodiment, it is possible to correctly log requests for resources from the server even if some of those requests are redirected by cache software 20 to a previously stored file. Further, in the preferred embodiment, cache software 20 does not itself make requests for information from server 12. Software 20 intercepts data which has been generated by server 12 as a result of a request. Caching is not performed as a separate task in the preferred embodiment. Another advantage of the preferred embodiment is that it permits portions of pages or other resources to be cached while other portions are not cached. Providing cache software 20 as a “plug-in” makes it possible for software 20 to remove itself from the process of servicing a request for data, such as HTTP data, as soon as it becomes clear that there is a reason why software 20 no longer needs to be involved in respect of the request in question.

Preferred implementations of the invention may include a computer system programmed to execute a method of the invention. The invention may also be provided in the form of a program product. The program product may comprise any medium which carries a set of computer-readable signals corresponding to instructions which, when run on a computer, cause the computer to execute a method of the invention. The program product may be distributed in any of a wide variety of forms. The program product may comprise, for example, physical media such as floppy diskettes, CD ROMs, DVDs, hard disk drives, flash RAM or the like or transmission-type media such as digital or analog communication links. The invention includes both the broad structures, apparatus, methods, and arrangements discussed herein as well as the details of implementation and combinations of details of implementation which are discussed herein.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A computer-implemented method for satisfying requests for dynamic data, the method comprising:
a) receiving a request for dynamic data;
b) determining whether a copy of the requested dynamic data is present in a cache data store;
c) if a copy of the requested dynamic data is present in the cache data store, modifying the request to request the copy of the dynamic data in the cache data store and passing the request to a server;
d) if a copy of the requested dynamic data is not present in the cache data store, requesting the dynamic data from a server, receiving a copy of the dynamic data from the server and storing the copy of the dynamic data in the data store.

2. The method of claim 1 comprising providing at least one rule defining one or more types of requests for data which are permitted to be filled from the cache data store, checking the request for dynamic data to determine whether the request for dynamic data is of a type which is permitted to be filled from the cache data store and, if not, passing the request to the server.

3. The method of claim 1 wherein the server comprises a web server and the request for dynamic data is a HTTP request.

4. The method of claim 3 wherein requesting the dynamic data from the server comprises generating a sub-request for the dynamic data.

5. The method of claim 1 comprising, after receiving a copy of the dynamic data from the server generating and forwarding to the server a request for the copy of the dynamic data in the data store.

6. The method of claim 1 wherein the server comprises Microsoft Internet Information Server software.

7. The method of claim 6 wherein determining whether a copy of the requested dynamic data is present in a cache data store is performed by a computer running instructions from Internet Server Application Programming Interface Filter software.

8. The method of claim 1 wherein the server comprises Apache Server software.

9. The method of claim 8 wherein determining whether a copy of the requested dynamic data is present in a cache data store is performed by a computer running instructions of an Apache Server module.

10. The method of claim 2 wherein the at least one rule comprises a condition on HTTP header information.

11. The method of claim 2 wherein the at least one rule comprises a condition on cookie information.

12. The method of claim 2 wherein the at least one rule comprises conditions on two or more of HTTP header information, cookie information and query string information.

13. The method of claim 1 wherein at least a portion of the copy of the dynamic data from the server is marked and storing the copy of the dynamic data in the data store comprises storing only unmarked portions of the copy of the dynamic data from the server.

14. The method of claim 13 comprising identifying the marked portion of the copy of the dynamic data by identifying a symbol marking the start of a portion of the data that should not be cached and identifying a symbol marking an end of the portion of the data that should not be cached.

15. The method of claim 13 wherein one or more individual files are identified as files which should not be cached.

16. The method of claim 13 comprising locating source code corresponding to the marked section of the copy of the requested data and writing the source code to the data store in place of the marked section.

17. The method of claim 1 comprising compressing the copy of the dynamic data before storing the copy of the dynamic data in the data store.

18. Apparatus for satisfying requests for dynamic data comprising a computer running software comprising instructions which, when run by the computer cause the computer to:
a) receive a request for dynamic data;
b) determine whether a copy of the requested dynamic data is present in a cache data store;
c) if a copy of the requested dynamic data is present in the cache data store, modify the request to request the copy of the dynamic data in the cache data store and pass the request to a server;
d) if a copy of the requested dynamic data is not present in the cache data store, request the dynamic data from a server, receive a copy of the dynamic data from the server and store the copy of the dynamic data in the data store.

19. A computer readable medium comprising instructions which, when executed by a computer, cause the computer to perform a method for satisfying requests for dynamic data, the method comprising:
a) receiving a request for dynamic data;
b) determining whether a copy of the requested dynamic data is present in a cache data store;
c) if a copy of the requested dynamic data is present in the cache data store, modifying the request to request the copy of the dynamic data in the cache data store and passing the request to a server;
d) if a copy of the requested dynamic data is not present in the cache data store, requesting the dynamic data from a server, receiving a copy of the dynamic data from the server and storing the copy of the dynamic data in the data store.
